(19) United States
(12) Patent Application Publication
(10) Pub. No.: US 2025/0053440 A1
(43) Pub. Date: Feb. 13, 2025

(54) VERIFYING TRUSTWORTHINESS OF WORKER NODES OF CLUSTER ENVIRONMENTS DURING WORKLOAD SCHEDULING

(71) Applicant: NVIDIA Corporation, Santa Clara, CA (US)

(72) Inventors: Binu Ramakrishnan, Fremont, CA (US); Soham Desai, Jacksonville, FL (US); Ayush Ambastha, Sunnyvale, CA (US); Aaron Kaloti, Santa Clara, CA (US)

(21) Appl. No.: 18/438,644

(22) Filed: Feb. 12, 2024

Related U.S. Application Data
(60) Provisional application No. 63/532,162, filed on Aug. 11, 2023.

(51) Int. Cl. G06F 9/48

(52) U.S. Cl. CPC G06F 9/4881

(57) ABSTRACT

A system can include a memory and a processing device, operatively coupled to the memory, to perform operations including receiving a workload, selecting, from a set of worker nodes of a cluster environment, a worker node for scheduling of the workload, determining whether the worker node is valid, including determining whether the worker node is trusted, and in response to determining that the worker node is valid, scheduling the workload with the worker node.

### CROSS-REFERENCE TO RELATED APPLICATION(S)

The present application claims priority to U.S. Provisional Patent Application No. 63/532,162, filed on Aug. 11, 2023 and entitled “VERIFYING TRUSTWORTHINESS OF WORKER NODES OF CLUSTER ENVIRONMENTS DURING WORKLOAD SCHEDULING”, the entire contents of which are hereby incorporated by reference herein.

### TECHNICAL FIELD

At least one embodiment pertains to processing resources used to perform and facilitate cluster environments, such as datacenters. For example, at least one embodiment pertains to technology for verifying trustworthiness of worker nodes of cluster environments during workload scheduling.

### BACKGROUND

A cluster environment can include a collection of nodes including a control plane and a set of workers nodes. The control plane is generally responsible for managing resources of the cluster environment, such as the set of worker nodes. The control plane can include a single node or multiple nodes. The set of worker nodes can include multiple computing devices linked by high-speed networks to form a cluster. The set of worker nodes can include one or more physical machines and/or one or more virtual machines. Each worker node can execute one or more applications. For example, an application can be executed within a container. A container is an executable unit of software in which application code is packaged along with its dependencies to allow an application to be deployed seamlessly across environments. For example, a container can include binary files, libraries, configuration files, etc. that are used to execute the application. That is, a container can provide isolation for an application hosted by the container from the external cluster environment. A worker node can execute one or more collections of containers, or workloads. Each collection of containers is the smallest deployable unit of computing that can be created and managed within the cluster environment. For example, a collection of containers can include multiple containers that are related to each other and/or share computing resources (e.g., network resources or storage resources). A collection of containers can be referred to as a pod.

### BRIEF DESCRIPTION OF DRAWINGS

Various embodiments in accordance with the present disclosure will be described with reference to the drawings, in which:

FIGS. 1A-1B illustrates an example system that can verify trustworthiness of worker nodes of a cluster environment during workload scheduling, in accordance with at least some embodiments;

FIGS. 2-4 are flow diagrams of example methods that can be used to verify trustworthiness of worker nodes of a cluster environment during workload scheduling, in accordance with at least some embodiments;

FIGS. 5A-5B are timing diagrams illustrating an example implementation of remote attestation of a worker node in a cluster environment, in accordance with at least some embodiments;

FIG. 6 is a state diagram illustrating example node state transitions during remote attestation of a worker node in a cluster environment, in accordance with at least some embodiments; and

FIG. 7 illustrates an example computer system, in accordance with at least some embodiments.

### DETAILED DESCRIPTION

A control plane of a cluster environment can schedule workloads to worker nodes within the cluster environment. The control plane can determine whether to schedule a workload to a worker node based on a set of criteria. For example, the set of criteria can include criteria relating to resource availability of a workload to handle the workload. However, some control planes fail to take the trustworthiness of a worker node into account as part of the set of criteria. As a result, the security of the cluster environment can be jeopardized.

Aspects of the present disclosure address the above and other deficiencies by ensuring that control planes of cluster environments verify the trustworthiness of worker nodes during workload scheduling. Verifying the trustworthiness of a worker node can include determining whether the worker node has a proper configuration prior. For example, an administrator of the cluster environment may want to ensure that a worker node that is connected within the cluster environment is legitimate and that hardware and/or software operated by the worker node is valid.

In some implementations, trustworthiness of a worker node in a cluster environment is verified by implementing remote attestation of the worker node. Remote attestation is a security process used to verify the integrity and configuration of a remote computing system or device. Remote attestation can enable the control plane, as a trusted entity of the cluster environment, to remotely verify that a worker node has booted securely, is running the expected software, and has not been tampered with or otherwise compromised.

To implement remote attestation of a worker node in a cluster environment, a control plane of the cluster environment can implement a trust verifier and the worker node can implement a trust agent. The trust verifier and each trust agent can be deployed as part of a set of trust components. In some implementations, the trust verifier is a service specific to the cluster environment. In some implementations, the trust verifier is a service that is shared among multiple cluster environments (e.g., a remote service). As will be described in further detail herein, the trust verifier and the trust agent can communicate with each other to implement an enrollment process to register and enroll a worker node within the cluster environment, and an attestation process to periodically validate the trustworthiness of the worker node after enrollment. In some implementations, the enrollment process and the attestation process are implemented using a trusted platform module (TPM) resident on the worker node. The TPM can securely store data to prevent extraction or tampering. Further details regarding the remote attestation of worker nodes in cluster environments will be described herein below. In some implementations, remote attestation of a worker node in a cluster environment can include implementing a Security Protocol and Data Model (SPDM).

Implementations described herein can enable numerous improvements to computer-related technology. For example, implementations described herein can improve cybersecurity within cluster environments.

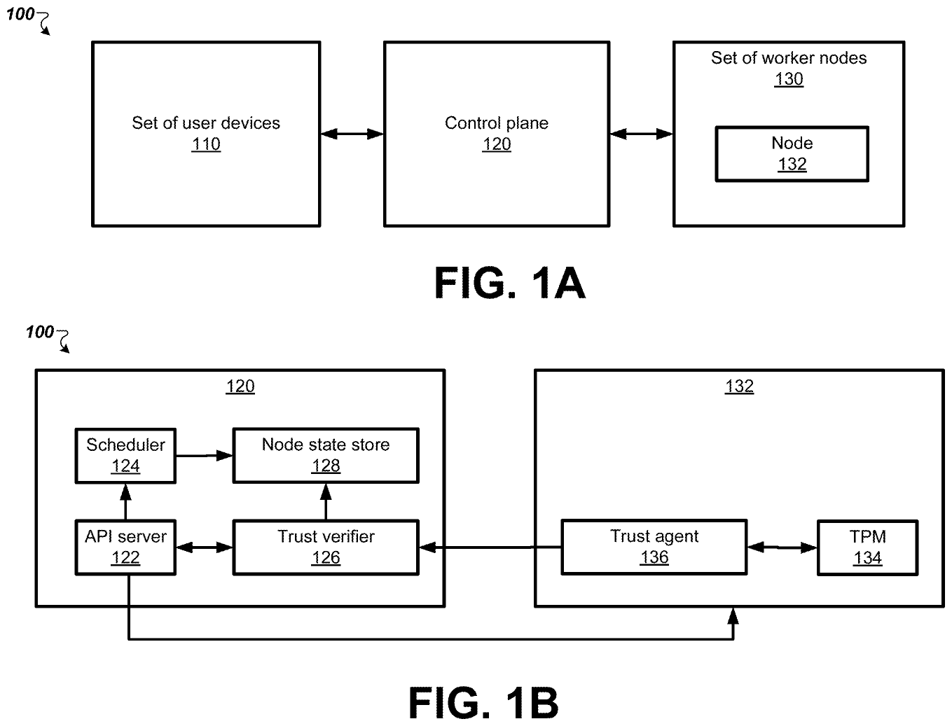

FIGS. 1A-1B illustrate an example system 100, in accordance with at least some embodiments. As shown in FIG. 1A, the system 100 includes a cluster environment that includes set of user devices 110, control plane 120 and a set of worker nodes (“nodes”) 130. In some implementations, set of user devices 110 includes one or more user devices used by one or more system administrators of system 100. In some implementations, set of nodes 130 includes at least one node 132 which may be a host device, a data processing unit (DPU), an Internet of Things (IoT) device, etc.

System 100 can be used to verify trustworthiness of a node in the cluster environment during workload scheduling. In some implementations, trustworthiness of a node in the cluster environment is verified by control plane 120 implementing remote attestation of the worker node. Further details regarding verifying trustworthiness of a node in the cluster environment during workload scheduling will now be described in further detail below with reference to FIG. 1B.

As shown in FIG. 1B, control plane 120 includes at least one application programming interface (API) server 122, workload scheduler (“scheduler”) 124, trust verifier 126 and node state store 128. In some implementations, trust verifier 126 is a service specific to the cluster environment of system 100. In some implementations, trust verifier 126 is a service that is shared among multiple cluster environments of system 100 (e.g., a remote service). API server 122, trust verifier 126 and node state store 128 can be used to implement remote attestation of nodes within a cluster environment.

In some implementations, system 100 implements an enrollment process that uses trust verifier 126 and trust agent 136 to securely enroll node 132 with control plane 120. The enrollment process can be implemented as part of an initialization process to initialize node 132. In some implementations, the enrollment process includes a registration phase during which node 132 is registered with control plane 120, and an enrollment phase during which node 132 is enrolled with control plane 120 after registration.

For example, assume that node 132 is a new worker node that requests to join the cluster environment. In response to control plane 120 identifying node 132 as a new worker node (e.g., node 132 is in an enrollment mode), API server 122 can perform a trust agent initialization process to initialize a trust agent on node 132. Performing the trust agent initialization process can include determining whether node 132 is valid. Determining whether node 132 is valid can include determining whether node 132 has a valid TPM. For example, node 132 has a valid TPM if it has a TPM, and the TPM is properly configured or functioning. If node 132 does not have a valid TPM (e.g., node 132 does not have a TPM or a TPM of node 132 is not properly configured or functioning), then the trust agent cannot be initialized on node 132. Otherwise, if node 132 has a valid TPM, then the trust agent can be initialized on node 132 and a registration phase can be initiated. In this example, it is assumed that node 132 includes valid TPM 134 and trust agent 136 has been initialized. TPM 134 can store a set of TPM data. For example, the set of TPM data can include at least one of: an endorsement key (Ek), a node name, or a node identifier (ID). The endorsement key is a public key linked to TPM 134. In some implementations, the set of TPM data (e.g., the endorsement key) is provisioned by a manufacturer of TPM 134.

Trust agent 136 can then initiate the registration phase to register node 132 with control plane 120 by sending a registration request to trust verifier 126. The registration request can include a set of registration data. For example, the set of registration data can include data indicative of at least one of: a name of the worker node or an identifier of the worker node. In some implementations, trust verifier 126 and trust agent 136 communicate using a TPM-backed transport layer security (TLS) protocol in which trust agent 136 sends at least a digital certificate to trust verifier 126 for verification. Examples of digital certificates include public key certificates (e.g., X.509 certificates).

In response to receiving the registration request from trust agent 136, trust verifier 126 can determine whether node 132 was previously registered with the cluster environment. In some implementations, trust verifier 126 is loaded with an allowed list (e.g., whitelist) of endorsement keys (e.g., public endorsement keys) associated with nodes (e.g., TPMs of nodes). The allowed list of endorsement keys can enable improved control over which nodes are allowed to register with trust verifier 126.

If node 132 was not previously registered with the cluster environment, then trust verifier 126 can cause API server 122 to create a node record for node 132, update a node state of node 132 to “awaiting make credential” within node state store 128, and cause data indicative of at least the name and/or ID of the node 132 to be stored within control plane 120 (e.g., within node state store 128). The node record can be a database entry or schema. In some implementations, the node record is a custom resource (CR). Trust verifier 126 can then send a registration response (e.g., acknowledgement (“Ack”)) to trust agent 136 to complete the registration process. In some implementations, the registration response is sent to trust agent 136 using the TLS protocol.

After receiving the registration response from trust verifier 126, trust agent 136 can initiate the enrollment phase by sending a make credential request to trust verifier 126. The make credential request can include a set of credential creation data. For example, the set of credential creation data can include at least one of: an ID of node 132, the endorsement key, an endorsement key certificate, an attestation key (Ak), etc. The attestation key is a public key can be used to sign attestation data. In some implementations, the attestation key is generated based at least in part on the endorsement key.

Upon receiving the make credential request from trust agent 136, trust verifier 126 can determine whether the endorsement key is valid. If not, then node 132 cannot be enrolled and the process ends. If the endorsement key is valid, then trust verifier 126 can cause a set of credential data to be generated. For example, the set of credential data can include a credential blob, a secret, an encrypted secret, and a secret expiration data for the secret (e.g., how long the secret is valid for). The encrypted secret can be generated by encrypting the secret with a suitable encryption key. Trust verifier 126 can cause API server 122 to update the node record for node 132, update the node state of node 132 to “awaiting activate credential” within node state store 128, and cause at least the attestation key, secret and the secret expiration data to be stored within control plane 120. Trust verifier 126 can then send a make credential response (Ack) to trust agent 136. In some implementations, the make credential response is sent to trust agent 136 using the TLS protocol. The make credential response can include a set of credential data. For example, the set of credential data can include the credential blob and the encrypted secret.

After receiving the make credential response from trust verifier 126, trust agent 136 can send an activate credential request to trust verifier 126. The activate credential request can include the secret (obtained by decrypting the encrypted secret received from trust verifier 126) and the node ID. Upon receiving the activate credential request from trust agent 136, trust verifier 126 can determine, based on the secret received from trust agent 136, whether node 132 can continue with the enrollment process. For example, trust verifier 126 can retrieve, via API sever 122, the node record, including the node state, the secret and the secret expiration data. Trust verifier 126 can then determine whether node 132 can continue with the enrollment process by determining whether node 132 is in the awaiting activate credential state, the secret received from API server 122 matches the secret received from trust agent 136, and that the secret has not expired in accordance with the secret expiration data. If trust verifier 126 determines that node 132 cannot continue with the enrollment process, then the enrollment process terminates. Determining that node 132 cannot continue with the enrollment process can include determining that node 132 is not in the awaiting activate credential state, the secrets do not match and/or the secret has expired. Otherwise, trust verifier 126 can cause API server 122 to update the node record for node 132, update the node state of node 132 to “awaiting digital certificate request” within node state store 128, and cause the stored secret to be deleted. Trust verifier 126 can then send an activate credential response (Ack) to trust agent 136. In some implementations, the activate credential response is sent to trust agent 136 using the TLS protocol.

After receiving the activate credential response from trust verifier 126, trust agent 136 can initiate a digital certificate provisioning process. Initiating the digital certificate provisioning process can include trust agent 136 sending a digital certificate request (e.g., TLS certificate request) to trust verifier 126. Upon receiving the digital certificate request from trust agent 136, trust verifier 126 can retrieve the node record for node 132 and determine whether node 132 can continue with the enrollment process by determining whether the node state of node 132 is in the awaiting digital certificate request state. If trust verifier 126 determines that node 132 cannot continue with the enrollment process (e.g., node 132 is not in the awaiting digital certificate request state), then the enrollment process terminates. Otherwise, trust verifier 126 can generate and sign a digital certificate as root certificate authority (CA) and cause API server 122 to update the node record for node 132, update the node state of node 132 to “awaiting set of reference trust measurements” within node state store 128. Trust verifier 126 can then send a digital certificate response (Ack) to trust agent 136. The digital certificate response includes a digital certificate (e.g., TLS certificate). In some implementations, the digital certificate response is sent to trust agent 136 using the TLS protocol.

The enrollment process can include trust verifier 126 establishing a set of reference trust measurements for node 132. The set of reference trust measurements can include one or more measurements defining a reference configuration state of node 132 (e.g., initial boot configuration state). For example, the set of reference trust measurements can include one or more measurements related to at least one of: the bootloader, operating system (OS), a driver, an application, integrity measurement architecture (IMA), etc. The IMA can be used to enhance system 100 with runtime file monitoring. In some implementations, a measurement is a digest. After establishing the set of reference trust measurements for node 132, trust verifier 126 can update the node state of node 132 to “awaiting attestation lease initialization” within node state store 128.

In some implementations, system 100 performs an attestation process to validate the trustworthiness of node 132. For example, an initial attestation process can be performed after node 132 successfully completes the enrollment process, and the attestation process can be periodically performed after the initial attestation process to confirm the trustworthiness of node 132.

To initiate an attestation process, trust agent 136 can send a get nonce request to trust verifier 126. In some implementations, the get nonce request is sent to trust verifier 126 using the TLS protocol. Upon receiving the get nonce request from trust agent 136, trust verifier 126 can retrieve the node record for node 132 and determine whether node 132 can continue with the attestation process by determining whether the node state of node 132 is “awaiting attestation lease initialization” or “attestation lease valid”. If the node state of node 132 is not awaiting attestation lease initialization or attestation lease valid, then the attestation process can end. Otherwise, trust verifier 126 can cause API server 122 to store nonce data including the nonce. In some implementations, the nonce data can further include a nonce time to live (TTL). The nonce TTL can reflect an amount of time during which trust verifier 126 can expect trust agent 136 to send an attestation request. Trust verifier 126 can then send a get nonce response (Ack) to trust agent 136. In some implementations, the get nonce response is sent to trust agent 136 using the TLS protocol.

After receiving the get nonce response, trust agent 136 can send an attestation request to trust verifier. For example, the attestation request can be an attestation quote verification request. In some implementations, the attestation request is sent to trust verifier 126 using the TLS protocol. The attestation request can include a set of attestation verification data. The set of attestation verification data can include a set of new trust measurements. The set of new trust measurements can be generated and stored in TPM 134. For example, TPM 134 can take measurements of various components of node 132 to generate a representation of the state of node 132 (e.g., during a boot process), and the set of new trust measurements can include digests of the new measurements. The set of new trust measurements can be stored within platform configuration registers (PCRs) of TPM 134. Accordingly, the set of new trust measurements can define a current configuration state of node 132. The number of new trust measurements can be equal to the number of reference trust measurements (e.g., the set of reference trust measurements and the set of new trust measurements have the same cardinality).

Trust verifier 126 can then determine whether the set of attestation verification data is valid. For example, determining whether the set of attestation verification data is valid can include determining whether the set of new trust measurements matches the set of reference trust measurements. If the set of new trust measurements is determined to match the set of reference trust measurements, this means that the trustworthiness of node 132 has been validated (e.g., attestation quote verification data is valid). In response, trust verifier 126 can update the node state of node 132 to “attestation lease valid” and send an attestation quote verification response (Ack) to trust agent 136. Attestation lease valid can indicate a trusted state of node 132.

The attestation verification response can include a proof of attestation (PoA) issued by trust verifier 126. The PoA can include a set of data that indicates the trustworthiness of the node 132 is validated for the amount of time (e.g., attestation lease start time and attestation lease end time). The PoA can be used as a cryptographic identity for node 132. To prevent an attacker from stealing the PoA, an authentication process can be performed to authenticate node 132 prior to sending the PoA. In some implementations, the authentication process is a TPM-based mutual TLS (mTLS) process.

In some implementations, the PoA is a digital certificate. In some implementations, the PoA is a PoA token. Examples of PoA tokens include JavaScript Object Notation (JSON) web tokens (JWTs), OpenID Connect (OIDC) tokens, etc. For example, a PoA token can include a header, a payload and a signature (e.g., header.payload.signature). The header can include PoA token metadata, such as token type, the method used to generate the digital signature, etc. The payload can include a set of fields that stores relevant information related to the PoA token. For example, the set of fields can include an “audience” field indicating the intended recipient of the PoA token (e.g., the trust agent). As another example, the set of fields can include an “expiration time” field indicating a timestamp when the PoA token will expire (e.g., is no longer valid). As another example, the set of fields can include an “issued at time” field indicating a timestamp when the PoA token was issued. As another example, the set of fields can include an “issuer” field identifying the issuer of the PoA token (e.g., the trust verifier). As another example, the set of fields can include a “subject” field identifying the worker node as the subject of the PoA token (e.g., node name and/or node identifier). As another example, the set of fields can include a not-before time field indicating a timestamp before which the PoA token must not be accepted for processing. As another example, the set of fields can include a “roles” field that identifies one or more roles for the PoA token (e.g., an array of roles). As another example, the set of fields can include a “metadata” field that identifies additional metadata for the PoA token. Examples of additional metadata can include an identifier of the cluster environment, a domain name of the worker node identifying the location of the worker node within a domain name system (DNS) hierarchy (e.g., fully qualified domain name), a last reboot timestamp identifying the last time that the worker node was rebooted, geographical coordinates of the worker node, etc. The signature can be used to verify the integrity and/or authenticity of the token. The header, the payload and the signature can each be encoded using a suitable encoding scheme to enable transmission of the PoA token between the trust verifier and the trust agent. If the payload includes confidential information, then the payload can be encrypted prior to being added to the PoA token. The signature can be generated based on at least one of the header or the payload. For example, the signature can be generated by combining the header and the payload and encoding the combination with a secret key.

Trust agent 136 can store a set of authentication data, including the PoA, locally within TPM 134 to be made available to other applications that may want to use the set of authentication data to authenticate node 132. The set of authentication data can further include, for example, a set of digital certificates. Examples of digital certificates include public key certificates (e.g., X.509 certificates). For example, an application can use the set of authentication data to authenticate node 132 to perform a workload in order to fetch credentials for node 132 that are needed for the workload.

If the set of attestation quote verification data is invalid (e.g., if the set of new trust measurements is determined not to match the set of reference trust measurements), this means that the trustworthiness of the node 132 has not been validated. In response, trust verifier 126 can update the node state of node 132 to “attestation failure”. Additionally, trust verifier 126 can cause an alert or message to be sent to the one or more user devices of set of user devices 110. The alert or message can indicate that node 132 is currently in an untrusted state, so that the one or more system administrators can address the now-untrusted node 132 (e.g., conduct necessary investigations).

In some implementations, the cluster environment facilitates workload scheduling and deployment to a worker node of the set of worker nodes. For example, a user device of set of user devices 110 can send a workload to control plane 120, and scheduler 124 can identify a suitable worker node to handle the workload, and schedule the workload to the suitable worker node. In some implementations, the workload is received from another device or system (not shown). In some implementations, the workload is an artificial intelligence (AI) or machine learning (ML) (“AI/ML”) model execution workload.

To identify the suitable worker node to handle the workload, scheduler 124 can select a first node of set of worker nodes 130. For example, scheduler 124 can identify the first node by determining that the first node is most suitable to handle the workload based on an analysis of available computing resources. Examples of computing resources include processing resources, storage resources, networking resources. In some implementations, a load balancing scheme is used to identify the first node.

In this example, the first node is node 132. Scheduler 124 can determine whether node 132 is trusted (e.g., the trust state of node 132 is attestation lease valid). If node 132 is trusted, then node 132 can be identified as the suitable worker node and scheduler 124 can schedule the workload to node 132.

In some implementations, workload identity data is generated for the workload after scheduling. The workload identity data can be used to prove that the workload scheduled to be executed by node 132 is valid. For example, the workload identity data can be a token or a digital certificate. In some implementations, the workload identity data is generated based on the PoA corresponding to node 132.

In some implementations, trust agent 136 can send a workload identity data creation request to control plane 120 (e.g., to trust verifier 126). The workload identity data creation request can include a set of data including the PoA and workload metadata. Control plane 120 can then determine whether the set of data received with the workload identity data creation request is valid. For example, control plane 120 can determine whether the PoA and the workload metadata is valid. If so, control plane 120 can generate the workload identity data and send the workload identity data to trust agent 136.

If node 132 is not trusted (e.g., the trust state of node 132 is attestation failure), then scheduler 124 can skip node 132, select another node of set of worker nodes 130, and determine whether the trust state of the other node maintained in node state store 128 is a trusted state. In some implementations, scheduler 124 sends an alert or message to the one or more user devices. The alert or message can indicate that node 132 is currently in an untrusted state, so that system administrators can address node 132 (e.g., conduct necessary investigations).

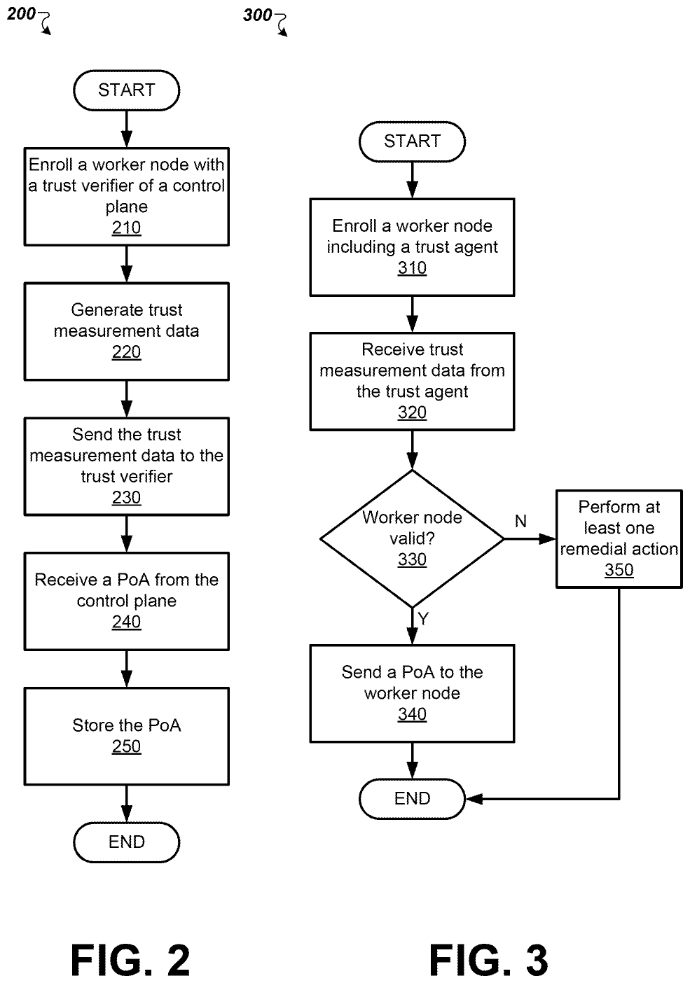

FIG. 2 illustrates a flow diagram of method 200 to implement remote attestation of worker nodes in cluster environments, according to at least one example embodiment. Method 200 can be performed by processing logic comprising hardware, software, firmware, or any combination thereof. In at least one embodiment, method 200 is performed within worker node (e.g., node 132), such by trust agent 136 described above with reference to FIGS. 1A-1B. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other diagrams are possible.

At operation 210, processing logic enrolls a worker node with a trust verifier of a control plane. The worker node can be included within a set of worker nodes of a cluster environment. As part of enrollment, the trust verifier can store reference trust measurement data corresponding to the worker node. In some implementations, enrolling the worker node with the trust verifier includes performing an enrollment process including a registration phase and an enrollment phase. For example, the registration phase can be initiated by processing logic sending, to the control plane (e.g., the trust verifier), a registration request to register the worker node with the trust verifier. If the registration process is successful, then the enrollment process can be initiated.

At operation 220, processing logic generates trust measurement data. In some implementations, the trust measurement data can be periodically generated to validate the worker node. In some implementations, the trust measurement data is generated on demand. For example the trust measurement data can be generated at some time after enrolling the worker node.

At operation 230, processing logic sends the trust measurement data to the trust verifier. More specifically, the trust verifier can compare the trust measurement data to the reference trust measurement data to determine whether the worker node is valid (e.g., can still be trusted).

At operation 240, processing logic receives a PoA from the control plane. More specifically, the PoA can be generated by the trust verifier in response to determining that the worker node is valid. In some implementations, the PoA is a PoA token. For example, the PoA token can be a JWT, OICD token, etc. In some implementations, the PoA is a PoA digital certificate.

At operation 250, processing logic stores the PoA. For example, the PoA can be stored within a TPM of the worker node. Further details regarding operations 210-250 are described above with reference to FIGS. 1A-1B and will now be described below with reference to FIGS. 3 and 5A-6B.

FIG. 3 illustrates a flow diagram of method 300 to implement remote attestation of worker nodes in cluster environments, according to at least one example embodiment. Method 300 can be performed by processing logic comprising hardware, software, firmware, or any combination thereof. In at least one embodiment, method 300 is performed within a control plane (e.g., control plane 120), such as by trust verifier 126 described above with reference to FIGS. 1A-1B. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other diagrams are possible.

At operation 310, processing logic enrolls a worker node including a trust agent. The worker node can be included within a set of worker nodes of a cluster environment. Enrolling the worker node can include storing reference trust measurement data corresponding to the worker node. For example, the trust state can be maintained within a node state store of a control plane. In some implementations, enrolling the worker node includes performing an enrollment process including a registration phase and an enrollment phase.

At operation 320, processing logic receives trust measurement data from the trust agent. The trust measurement data can be periodically generated by the node (e.g., the TPM).

At operation 330, processing logic determines whether the worker node is valid. Determining whether the worker node is valid can include determining whether the trust measurement data matches the reference trust measurement data.

If the worker node is determined to be valid at operation 330, then processing logic can send a PoA to the worker node at operation 340. Additionally, processing logic can cause the trust state of the worker node to be updated to trusted. For example, the PoA can be received by the trust agent and stored within a TPM of the worker node. In some implementations, the PoA is a PoA token. For example, the PoA token can be a JWT, OICD token, etc. In some implementations, the PoA is a PoA digital certificate.

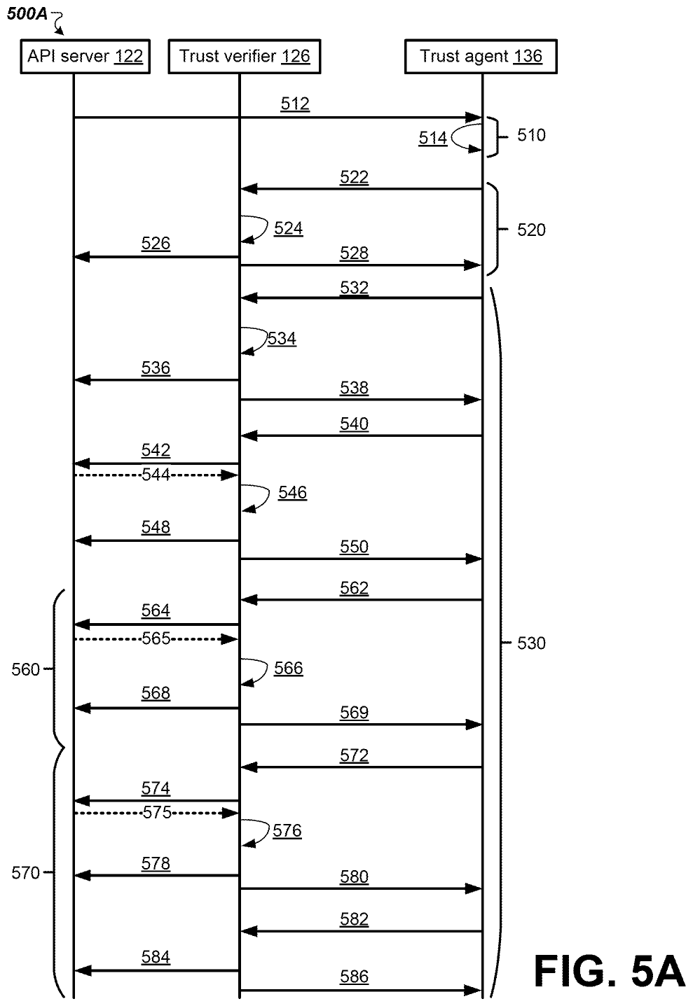

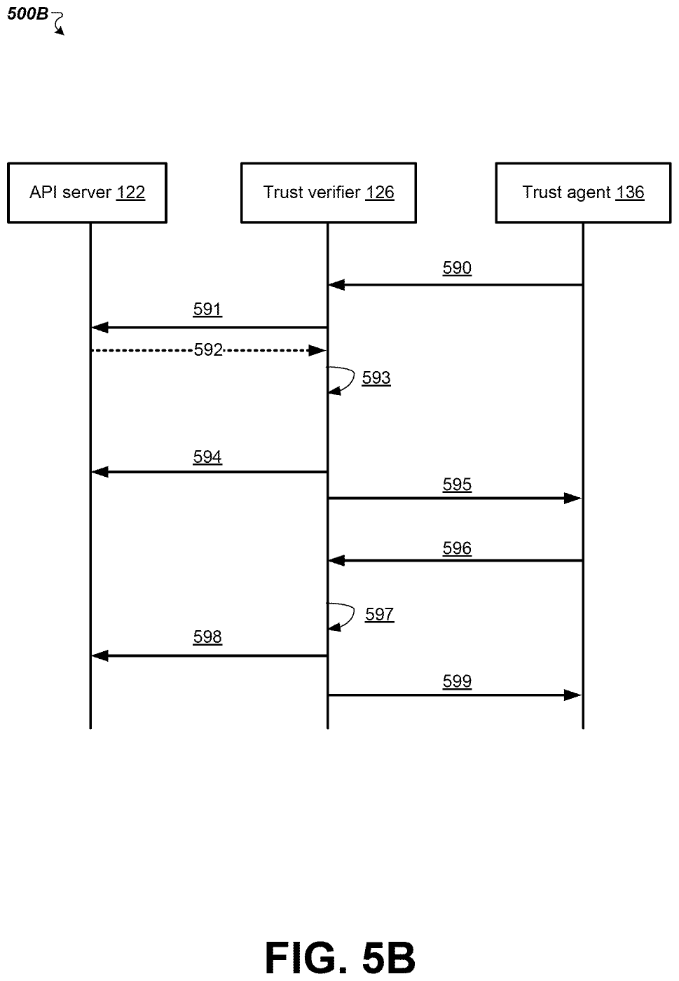

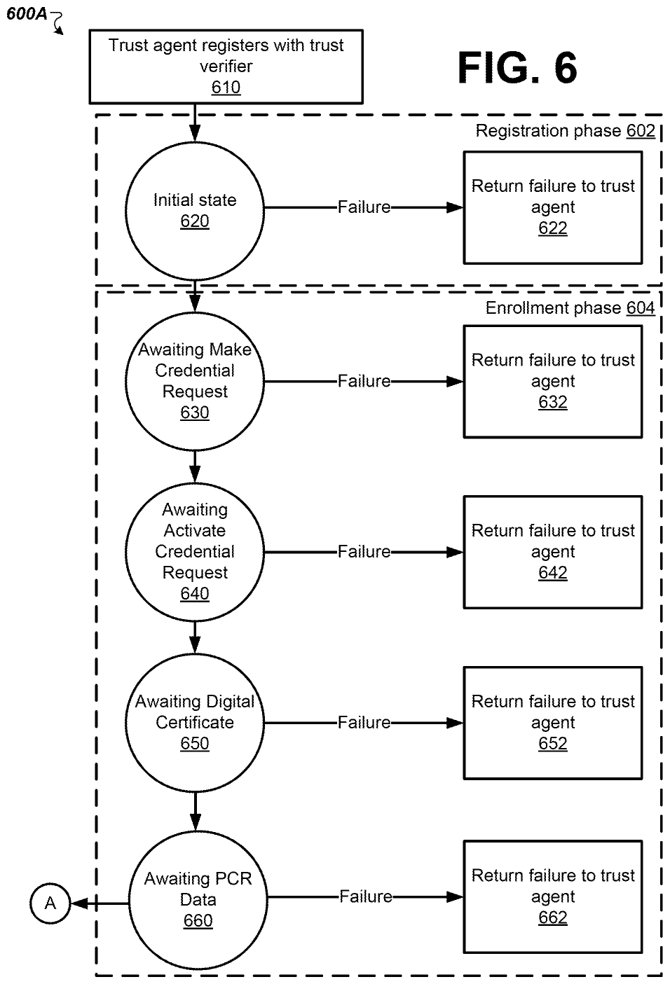

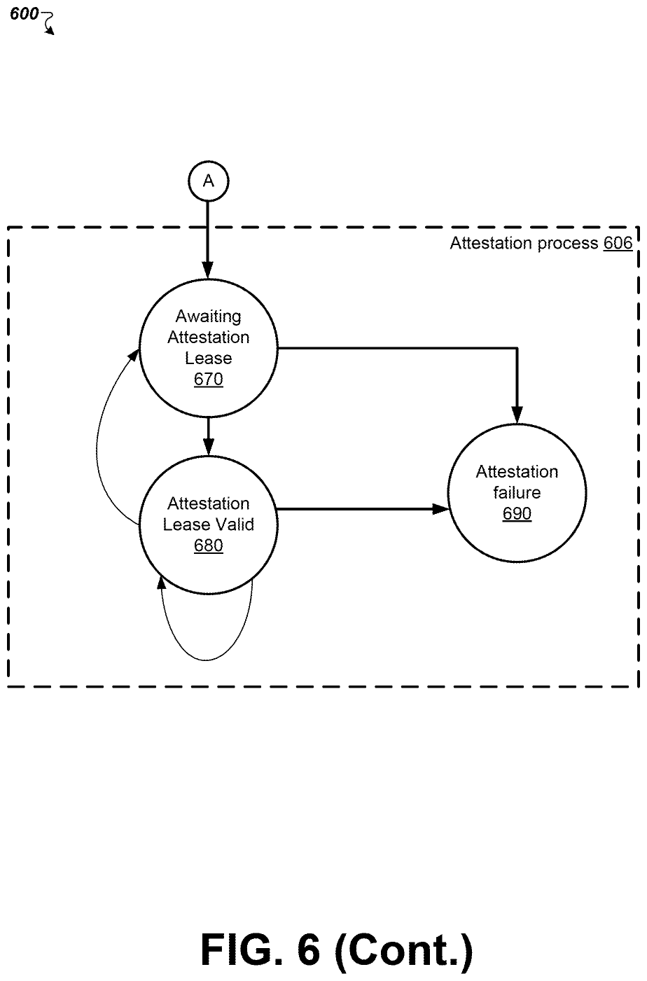

It the worker node is determined to be invalid at operation 330 (e.g., the trust state of the worker node is an untrusted state), then processing logic can cause at least one remedial action to be performed at operation 350. For example, causing the at least one remedial action to be performed can include causing the trust state of the worker node to be updated to an untrusted state. In some implementations, causing the at least one remedial action to be performed includes sending an alert or message to at least one user device identifying the worker node as being untrustworthy. Further details regarding operations 310-350 are described above with reference to FIGS. 1A-2 and will be described below with reference to FIGS. 5A-6B.

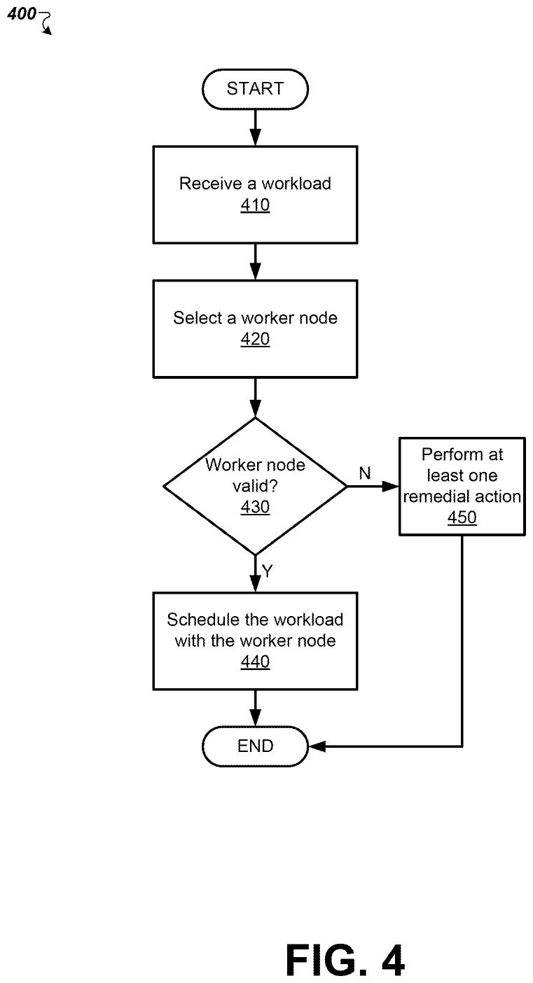

FIG. 4 illustrates a flow diagram of method 400 to implement verify trustworthiness of worker nodes of a cluster environment during workload scheduling, according to at least one example embodiment. Method 400 can be performed by processing logic comprising hardware, software, firmware, or any combination thereof. In at least one embodiment, method 400 is performed within a control plane (e.g., control plane 120), such as by API server 122 and/or trust verifier 126 described above with reference to FIGS. 1A-1B. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other diagrams are possible.

At operation 410, processing logic receives a workload. In some implementations, the workload is received from a user device. In some implementations, the workload is received from another device or system. For example, the workload can be a job. In some implementations, the workload is an AI/ML model execution workload.

At operation 420, processing logic selects a worker node. More specifically, the worker node can be selected from a set of worker nodes of a cluster environment. A control plane of the cluster environment can maintain a trust state of the worker node.

At operation 430, processing logic determines whether the worker node is valid. Determining whether the worker node is valid can include determining whether the worker node is trustworthy. For example, determining whether the worker node is trustworthy can include determining whether the trust state of the worker node is a trusted state. If the worker node is determined to be valid at operation 430, then processing logic can schedule the workload with the worker node at operation 440. In some implementations, scheduling the workload includes generating workload identity data corresponding to the scheduled workload.

If the worker node is determined to be invalid at operation 430 (e.g., the trust state of the worker node is an untrusted state), then processing logic can cause at least one remedial action to be performed at operation 450. For example, causing the at least one remedial action to be performed can include sending an alert or message to at least one user device identifying the worker node as being untrustworthy. Further details regarding operations 410-450 are described above with reference to FIGS. 1A-3 and will be described in further detail below with reference to FIGS. 5A-6B.

FIGS. 5A-5B are timing diagrams illustrating an example implementation of remote attestation of a worker node in a cluster environment, in accordance with at least some embodiments. For example, FIG. 5A is a timing diagram 500A illustrating an example implementation of an enrollment process to enroll the worker node in the cluster environment. Timing diagram 500A includes API server 122, trust verifier 126 and trust agent 136, as described above with reference to FIG. 1B.

As shown, the enrollment process can include trust agent initialization phase 510. During trust agent initialization phase 510, API server 122 can initialize a trust agent daemonset (512). For example, API server 122 can send a request to trust agent 136 to initialize the trust agent daemonset. Upon receiving the request to initialize the trust agent daemonset, trust agent 136 can validate a worker node (514). Validating the worker node can include at least one of resetting TPM settings, reusing TPM settings, checking for TPM functioning, and obtaining a set of worker node data. For example, the set of worker node data can include EkPub, a name of the worker node and/or an identifier of the worker node. After the worker node is validated, trust agent initialization phase 510 is complete.

The enrollment process can then proceed to registration phase 520. During registration phase 520, trust agent 136 can send a worker node registration request (“registration request”) to trust verifier 126 (522) (e.g., TLS+token). The registration request can include an identifier of the worker node and/or the name of the worker node. Upon receiving the registration request, trust verifier 126 can check if the worker node was previously registered (524). If not, trust verifier 126 can send a new node record request to API server 122 to create a new node record for the worker node (526). In some implementations, the new node record for the worker node is a new CR. This can cause a state of the worker node to be updated to “Awaiting Make Credential” and API server 122 can cause the identifier and/or name of the worker node to be stored. If the worker node was previously registered, or after the new node record request has been sent to API server 122, trust verifier can send a worker node registration (“registration”) confirmation response to trust agent 136 (528) (e.g., TLS). After the registration confirmation response is received by trust agent 136, registration phase 520 is complete.

The enrollment process can then proceed to enrollment phase 530. During enrollment phase 530, trust agent 136 can send a make credential request to trust verifier 126 (532) (e.g., TLS+token). For example, the make credential request can include a set of data including at least one of: an identifier of the worker node, AkPub, AkName, EkPub, or EkCert. Upon receiving the make credential request, trust verifier 126 can validate the make credential request (534). For example, validating the make credential request can include checking if the set of data is expected.

If so, trust verifier 126 can generate a credential blob (“cred blob”), encoded secret and a secret TTL. Then, trust verifier 126 can send an update node record request to API server 122 to update the node record (e.g., CR) for the worker node (536). For example, the update node record request can include a set of data including AkPub, AkName, the secret and the secret TTL. This can cause the state of the worker node to be updated to “Awaiting Activate Credential” and API server 122 can cause AkPub, AkName, secret and secret TTL to be stored. Trust verifier 126 can send a make credential response to trust agent 136 (538) (e.g., TLS). For example, the make credential response can include the cred blob and enc secret.

Upon receiving the make credential response, trust agent 136 can send an activate credential request to trust verifier 126 (540) (e.g., TLS+token). The activate credential request can include the secret and the identifier of the worker node. Upon receiving the activate credential request, trust verifier 126 can request the node record for the worker node from API server 122 (542), and API server 122 can return the node record for the worker node to trust verifier 126 (544). Trust verifier 126 can then validate the node record for the worker node received from API server 122 (546). For example, validating the node record for the worker node can include validating the state, the secret, and the secret TTL. Upon validating the node record for the worker node, trust verifier 126 can send an update node record request to API server 122 to update the node record for the worker node (548). This can cause the state of the worker node to be updated to “Awaiting Digital Certificate Request” and API server 122 can cause the secret to be deleted. Trust verifier 126 can then send an activate credential response to trust agent 136 (550) (e.g., TLS). More specifically, the activate credential response is the response to the activate credential request received by trust verifier 126 from trust agent 136 at step 540. The activate credential response can include establishing a trust relationship with respect to trust agent 136, and trust verifier 126 can maintain the trust relationship for subsequent connections. For example, establishing the trust relationship can include setting a Trust On First Use (TOFU) for trust agent 136 (e.g., TOFU=true).

After establishing the trust relationship, enrollment phase 530 can further include digital certificate provisioning stage 560. In some implementations, digital certificate provisioning includes mTLS certificate provisioning. To initiate digital certificate provisioning stage 560, trust agent 136 can send a request digital certificate request to trust verifier 126 (562) (e.g., TLS+token). For example, the request digital certificate request can include a set of digital certificate request data, such as an identifier of the worker node. Upon receiving the request digital certificate request, trust verifier 126 can request the node record for the worker node from API server 122 (564), and API server 122 can return the node record for the worker node to trust verifier 126 (565). Trust verifier 126 can then validate the node record for the worker node received from API server 122 (566). For example, validating the node record for the worker node can include validating the state, the TLS key sign, and generating and signing a client certificate as a root CA. Upon validating the node record for the worker node, trust verifier 126 can send an update node record request to API server 122 to update the node record for the worker node (568). This can cause the state of the worker node to be updated to “Awaiting PCR data” representing that API server 122 is waiting to receive a PCR data (e.g., a PCR digest). Trust verifier 126 can then send a request digital certificate response (569) to trust agent 136 (e.g., TLS) to complete the digital certificate provisioning process. For example, the request digital certificate response can include the digital certificate (e.g., TLS certificate).

In some implementations, enrollment phase 530 further includes PCR generation stage 570. To initiate PCR generation stage 570, trust agent 136 can send a get nonce request to trust verifier 126 (572) (e.g., TLS+token). For example, the get nonce request can include the identifier of the worker node. Upon receiving the get nonce request, trust verifier 126 can request the node record for the worker node from API server 122 (574), and API server 122 can return the node record for the worker node to trust verifier 126 (575). Trust verifier 126 can then validate the node record for the worker node received from API server 122 (576). For example, validating the node record for the worker node can include validating the state, and generating nonce data (e.g., the nonce and nonce TTL). Upon validating the node record for the worker node, trust verifier 126 can send an update node record request to API server 122 to update the node record for the worker node (578). For example, API server 122 can store the nonce data (e.g., the nonce and the nonce TTL). Trust verifier 126 can then send a get nonce response (580) to trust agent 136 (e.g., TLS). For example, the get nonce response can include the nonce and a PCR list.

Trust agent 136 can then send a store PCR measurement request to trust verifier 126 (582) (e.g., TLS+token). For example, the store PCR measurement request can include attestation data, a PCR map, an event log, and the identifier of the worker node. Upon receiving the store PCR measurements request, trust verifier 126 can send an update node record request to API server 122 to update the node record for the worker node (584). For example, API server 122 can store a PCR digest and the PCR map. This can cause the state of the worker node to be updated to “Awaiting Attestation Lease” representing that API server 122 is waiting for an attestation lease to be assigned by trust verifier 126. Trust verifier 126 can then send a store PCR measurement response to trust agent 136 (586) (e.g., TLS), which can complete enrollment phase 530. As will now be described below with reference to FIG. 5B, after enrollment of the worker node, periodic attestation of the worker node can be performed. Further details regarding FIG. 5B are described above with reference to FIGS. 1A-4 and will be described below with reference to FIG. 6.

FIG. 5B is a timing diagram 500B illustrating an example implementation of remote attestation of a worker node in a cluster environment, in accordance with at least some embodiments. Timing diagram 500B includes API server 122, trust verifier 126 and trust agent 136, as described above with reference to FIGS. 1B and 5A. It is assumed that the worker node has been enrolled as described above with reference to FIG. 5A, and that the state of the worker node is currently “Awaiting Attestation Lease”, which represents that the worker node is waiting for an attestation lease to be assigned by trust verifier 126. The operations shown in FIG. 5B can be repeated periodically to enable periodic attestation of the worker node.

As shown, to initiate an attestation process of a worker node, trust agent 136 can send a get nonce request to trust verifier 126 (590) (e.g., mTLS or token). Upon receiving the get nonce request, trust verifier 126 can request the node record (e.g., CR) for the worker node from API server 122 (591) and API server 122 can return the node record for the worker node to trust verifier 126 (592). Trust verifier 126 can then validate the node record for the worker node received from API server 122 (593). For example, validating the node record for the worker node can include at least one of validating the node state (e.g., Awaiting Attestation Lease) or checking that an attestation lease for the worker node is valid. Upon validating the node record for the worker node, trust verifier 126 can cause API server to store nonce data (594) (e.g., the nonce data described above with reference to FIG. 5A). Trust verifier 126 can then send a get nonce response to trust agent 136 (595) (e.g., mTLS or token).

After receiving the get nonce response, trust agent 136 can send a verify attestation quote request to trust verifier 126 (596) (e.g. mTLS or token). Trust verifier 126 can then validate a set of attestation quote verification data (597). For example, the set of attestation quote verification data can include the nonce data, a set of PCR values, and an event log. Upon validating the set of attestation quote verification data, trust verifier 126 can send an update node record request to API server 122 to update the node record for the worker node (598). This can cause the state of the worker node to be updated to “Attestation Lease Valid” representing that the attestation lease assigned by trust verifier 126 for trust agent 136 is valid. Trust verifier 126 can then send a verify attestation quote response to trust agent 136 (599) (e.g., mTLS or token). The verify attestation quote response can include data indicating a start time of the attestation lease and an end time of the attestation lease. Steps 591-599 can be repeated periodically to enable periodic attestation of the worker node. Further details regarding FIG. 5B are described above with reference to FIGS. 1A-4 and will now be described below with reference to FIG. 6.

FIG. 6 is a state diagram 600 illustrating example node state transitions during an enrollment process to enroll a worker node in a cluster environment, and remote attestation of a worker node in a cluster environment, in accordance with at least some embodiments. As shown, the enrollment process includes registration phase 602 and enrollment phase 604. Registration phase 602 can be initiated in response to a trust agent (e.g., trust agent 136 of FIGS. 1B and 5A-5B) registering with a trust verifier (e.g., trust verifier 126 of FIGS. 1B and 5A-5B) at operation 610. For example, the trust agent can be registered with the trust verifier during a trust agent initialization phase (e.g., trust agent initialization phase 510 of FIG. 5A). This causes a worker node to be placed in initial state 620 (e.g., by causing an initial node record (e.g., CR) to be created for the worker node). That is, initial state 620 can be a default state in which the node record for the worker node is created.

It is then determined whether the state of the worker node is allowed transition from initial state 620. If there is a failure to enable the state of the worker node to transition from initial state 620, then the failure can be returned back to the trust agent at operation 622 to prevent the state transition. One example of a failure is that the worker node does not have a TPM, or the TPM is not properly configured.

Otherwise, if the state of the worker node is allowed to transition from initial state 620 (e.g., the worker node has a properly configured TPM), then enrollment phase 604 can be initiated by transition the state of the worker node to an “Awaiting Make Credential Request” state 630 to wait for a make credential request to be received from the trust agent.

It is then determined whether the state of the worker node is allowed transition from Awaiting Make Credential Request state 630. If there is a failure to enable the state of the worker node to transition from Awaiting Make Credential Request state 630, then the failure can be returned back to the trust agent at operation 632 to prevent the state transition. One example of a failure is failure of the trust verifier to validate a set of data of a make credential request received from the trust agent (e.g., EkPub).

Otherwise, if the state of the worker node is allowed to transition from Awaiting Make Credential Request state 630 (e.g., the set of data of the make credential request is valid), then the state of the worker node can transition to an “Awaiting Activate Credential Request” state 640 to wait for an activate credential request to be received from the trust agent.

It is then determined whether the state of the worker node is allowed transition from Awaiting Activate Credential Request state 640. If there is a failure to enable the state of the worker node to transition from Awaiting Activate Credential Request state 640, then the failure can be returned back to the trust agent at operation 642 to prevent the state transition. One example of a failure is failure of the trust verifier to validate a set of data of a activate credential request received from the trust agent (e.g., a secret).

Otherwise, if the state of the worker node is allowed to transition from Awaiting Activate Credential Request state 640 (e.g., the set of data of the activate credential request is valid), then the state of the worker node can transition to an “Awaiting Digital Certificate Request” state 650 to wait for a digital certificate (e.g., mTLS certificate) request to be received from the trust agent.

It is then determined whether the state of the worker node is allowed transition from Awaiting Digital Certificate Request state 650. If there is a failure to enable the state of the worker node to transition from Awaiting Digital Certificate Request state 650, then the failure can be returned back to the trust agent at operation 652 to prevent the state transition. One example of a failure is failure of the trust verifier to validate a set of data received from the trust agent that can be used to generate a digital certificate that can be used for attestation (e.g., TLS certificate).

Otherwise, if the state of the worker node is allowed to transition from Awaiting Digital Certificate Request state 650 (e.g., the set of data used to generate the digital certificate is valid), then the state of the worker node can transition to an “Awaiting PCR Data” state 660 to wait for PCR data (e.g., a PCR digest) to be received from the trust agent.

It is then determined whether the state of the worker node is allowed transition from Awaiting PCR Data state 660. If there is a failure to enable the state of the worker node to transition from Awaiting PCR Data state 660, then the failure can be returned back to the trust agent at operation 662 to prevent the state transition. One example of a failure is failure of the trust verifier to receive a valid PCR quote.

Otherwise, if the state of the worker node is allowed to transition from Awaiting PCR Data state 660 (e.g., the PCR quote received by the trust verifier is valid), then the state of the worker node can complete the enrollment process, which can initiate attestation process 606. For example, the state of the worker node can transition to “Awaiting Attestation Lease” state 670 to wait for the trust verifier to assign an attestation lease to the trust agent. The worker node can reach Awaiting Lease Initialization state 670 if (1) the worker node has just registered and an initial attestation check is pending to provide an initial attestation lease for the trust agent or (2) the previously assigned attestation lease for the trust agent has expired and a new attestation lease is needed.

It is then determined whether the state of the worker node is allowed transition from Awaiting Attestation Lease state 670. If the state of the worker node is allowed to transition from Awaiting Attestation Lease state 670 (e.g., the attestation lease data matches expected values), then an attestation lease can be issued or renewed for the worker node and the state of the worker node can transition to “Attestation Lease Valid” state 680. That is, the attestation lease for the trust agent has been validated. Periodic attestation can be performed to ensure that the attestation lease for the trust agent is valid, as indicated by operation 682. Additionally, if the attestation lease for the trust agent has expired, the state of the worker node can transition back to Awaiting Attestation Lease” state 670 so that a new attestation lease can be issued.

If there is a failure in allowing the worker node to transition from Awaiting Attestation Lease state 670 to Attestation Lease Valid state 680 (or vice versa) (e.g., a failure during attestation lease initialization or attestation lease renewal), then an attestation failure for the worker node can be determined at operation 690. One example of a failure is failure of attestation lease data (e.g., PCR data) to match expected values (e.g., quote signature failed, quote PCR digest mismatch, event log replay failure and/or nonce mismatch). Further details regarding FIG. 6 are described above with reference to FIGS. 1-5B.

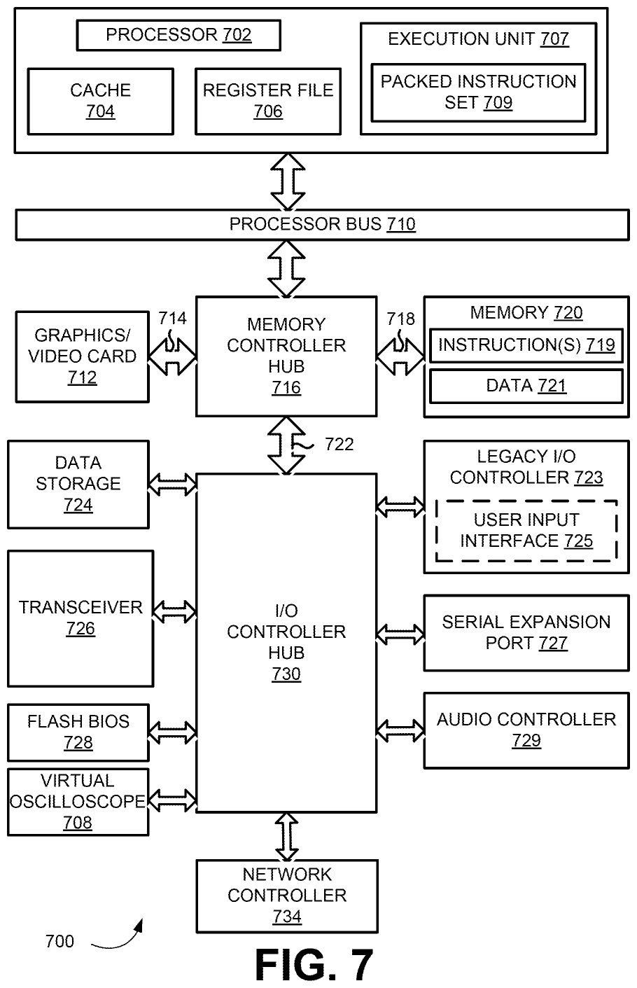

FIG. 7 illustrates a computer system 700, in accordance with at least one embodiment. In at least one embodiment, computer system 700 may be a system with interconnected devices and components, an SOC, or some combination. In at least one embodiment, computer system 700 is formed with a processor 702 that may include execution units to execute an instruction. In at least one embodiment, computer system 700 may include, without limitation, a component, such as processor 702 to employ execution units including logic to perform algorithms for processing data. In at least one embodiment, computer system 700 may include processors, such as PENTIUM® Processor family, Xcon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 700 may execute a version of WINDOWS' operating system available from Microsoft Corporation of Redmond, Wash., although other operating systems (UNIX and Linux for example), embedded software, and/or graphical user interfaces, may also be used.

In at least one embodiment, computer system 700 may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (DSP), an SoC, network computers (“NetPCs”), set-top boxes, network hubs, wide area network (“WAN”) switches, or any other system that may perform one or more instructions. In an embodiment, computer system 700 may be used in devices such as graphics processing units (GPUs), network adapters, central processing units and network devices such as switch (e.g., a high-speed direct GPU-to-GPU interconnect such as the NVIDIA GH100 NVLINK or the NVIDIA Quantum 2 64 Ports InfiniBand NDR Switch).

In at least one embodiment, computer system 700 may include, without limitation, processor 702 that may include, without limitation, one or more execution units 707 that may be configured to execute a Compute Unified Device Architecture (“CUDA”) (CUDA® is developed by NVIDIA Corporation of Santa Clara, CA) program. In at least one embodiment, a CUDA program is at least a portion of a software application written in a CUDA programming language. In at least one embodiment, computer system 700 is a single processor desktop or server system. In at least one embodiment, computer system 700 may be a multiprocessor system. In at least one embodiment, processor 702 may include, without limitation, a CISC microprocessor, a RISC microprocessor, a VLIW microprocessor, a processor implementing a combination of instruction sets, or any other processor device, such as a digital signal processor, for example. In at least one embodiment, processor 702 may be coupled to a processor bus 710 that may transmit data signals between processor 702 and other components in computer system 700.

In at least one embodiment, processor 702 may include, without limitation, a Level 1 (“L1”) internal cache memory (“cache”) 704. In at least one embodiment, processor 702 may have a single internal cache or multiple levels of internal cache. In at least one embodiment, cache memory may reside external to processor 702. In at least one embodiment, processor 702 may also include a combination of both internal and external caches. In at least one embodiment, a register file 706 may store different types of data in various registers including, without limitation, integer registers, floating point registers, status registers, and instruction pointer register.

In at least one embodiment, execution unit 707, including, without limitation, logic to perform integer and floating point operations, also resides in processor 702. Processor 702 may also include a microcode (“ucode”) read only memory (“ROM”) that stores microcode for certain macro instructions. In at least one embodiment, execution unit 707 may include logic to handle a packed instruction set 709. In at least one embodiment, by including packed instruction set 709 in an instruction set of a general-purpose processor 702, along with associated circuitry to execute instructions, operations used by many multimedia applications may be performed using packed data in a general-purpose processor 702. In at least one embodiment, many multimedia applications may be accelerated and executed more efficiently by using full width of a processor's data bus for performing operations on packed data, which may eliminate a need to transfer smaller units of data across a processor's data bus to perform one or more operations one data element at a time.

In at least one embodiment, an execution unit may also be used in microcontrollers, embedded processors, graphics devices, DSPs, and other types of logic circuits. In at least one embodiment, computer system 700 may include, without limitation, a memory 720. In at least one embodiment, memory 720 may be implemented as a DRAM device, an SRAM device, flash memory device, or other memory device. Memory 720 may store instruction(s) 719 and/or data 721 represented by data signals that may be executed by processor 702.

In at least one embodiment, a system logic chip may be coupled to processor bus 710 and memory 720. In at least one embodiment, the system logic chip may include, without limitation, a memory controller hub (“MCH”) 716, and processor 702 may communicate with MCH 716 via processor bus 710. In at least one embodiment, MCH 716 may provide a high bandwidth memory path 718 to memory 720 for instruction and data storage and for storage of graphics commands, data and textures. In at least one embodiment, MCH 716 may direct data signals between processor 702, memory 720, and other components in computer system 700 and to bridge data signals between processor bus 710, memory 720, and a system I/O 522. In at least one embodiment, system logic chip may provide a graphics port for coupling to a graphics controller. In at least one embodiment, MCH 716 may be coupled to memory 720 through high bandwidth memory path 718 and graphics/video card 712 may be coupled to MCH 716 through an Accelerated Graphics Port (“AGP”) interconnect 714.

In at least one embodiment, computer system 700 may use system I/O 722 that is a proprietary hub interface bus to couple MCH 716 to I/O controller hub (“ICH”) 730. In at least one embodiment, ICH 730 may provide direct connections to some I/O devices via a local I/O bus. In at least one embodiment, local I/O bus may include, without limitation, a high-speed I/O bus for connecting peripherals to memory 720, a chipset, and processor 702. Examples may include, without limitation, an audio controller 729, a firmware hub (“flash BIOS”) 728, a transceiver 726, a data storage 724, a legacy I/O controller 723 containing a user input interface 725 and a keyboard interface, a serial expansion port 727, such as a USB, and a network controller 734. Data storage 724 may comprise a hard disk drive, a floppy disk drive, a CD-ROM device, a flash memory device, or other mass storage device. In an embodiment, the transceiver 726 includes a virtual oscilloscope 708.

In at least one embodiment, FIG. 7 illustrates a system, which includes interconnected hardware devices or “chips” in the transceiver 726—e.g., the transceiver 726 includes a chip-to-chip interconnect. In at least one embodiment, FIG. 7 may illustrate an exemplary SoC. In at least one embodiment, devices illustrated in FIG. 7 may be interconnected with proprietary interconnects, standardized interconnects (e.g., PCIe), or some combination thereof. In at least one embodiment, one or more components of system 700 are interconnected using compute express link (“CXL”) interconnects. Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit the disclosure to a specific form or forms disclosed, but on the contrary, the intention is to cover all modifications, alternative constructions, and equivalents falling within the spirit and scope of the disclosure, as defined in appended claims.

Use of terms “a” and “an” and “the” and similar referents in the context of describing disclosed embodiments (especially in the context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitations of ranges of values herein are merely intended to serve as a shorthand method of referring individually to each separate value falling within the range, unless otherwise indicated herein, and each separate value is incorporated into the specification as if it were individually recited herein. In at least one embodiment, the use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in an illustrative example of a set having three members, conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, the number of items in a plurality is at least two, but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause a computer system to perform operations described herein. In at least one embodiment, a set of non-transitory computer-readable storage media comprises multiple non-transitory computer-readable storage media and one or more of individual non-transitory storage media of multiple non-transitory computer-readable storage media lack all of the code while multiple non-transitory computer-readable storage media collectively store all of the code. In at least one embodiment, executable instructions are executed such that different instructions are executed by different processors.

Accordingly, in at least one embodiment, computer systems are configured to implement one or more services that singly or collectively perform operations of processes described herein and such computer systems are configured with applicable hardware and/or software that enable the performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

All references, including publications, patent applications, and patents, cited herein are hereby incorporated by reference to the same extent as if each reference were individually and specifically indicated to be incorporated by reference and were set forth in its entirety herein.

In description and claims, terms “coupled” and “connected,” along with their derivatives, may be used. It should be understood that these terms may not be intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “receiving,” “determining,” “obtaining,” “generating,” “initiating,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transform that electronic data into other electronic data that may be stored in registers and/or memory. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as the system may embody one or more methods and methods may be considered a system.

In the present document, references may be made to obtaining, acquiring, receiving, or inputting analog or digital data into a subsystem, computer system, or computer-implemented machine. In at least one embodiment, the process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or inter-process communication mechanism.

Although descriptions herein set forth example embodiments of described techniques, other architectures may be used to implement described functionality, and are intended to be within the scope of this disclosure. Furthermore, although specific distributions of responsibilities may be defined above for purposes of description, various functions and responsibilities might be distributed and divided in different ways, depending on circumstances.

Furthermore, although the subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A system comprising:
a memory; and
a processing device, operatively coupled to the memory, to perform operations comprising:
receiving a workload;
selecting, from a set of worker nodes of a cluster environment, a worker node for scheduling of the workload;
determining whether the worker node is valid, including determining whether the worker node is trusted; and
in response to determining that the worker node is valid, scheduling the workload with the worker node.

2. The system of claim 1, wherein selecting the worker node comprises identifying the worker node by using load balancing based on an analysis of available computing resources.

3. The system of claim 1, wherein determining whether the worker node is trusted comprises determining whether an attestation lease associated with a trust agent of the worker node is valid.

4. The system of claim 1, wherein the operations further comprise:
obtaining workload identity data corresponding to the workload; and
validating the workload using the workload identity data.

5. The system of claim 4, wherein the operations further comprise obtaining a proof of attestation corresponding to the worker node, and wherein the workload identity data is generated based on the proof of attestation.

6. The system of claim 1, wherein the operations further comprise, in response to determining that the worker node is invalid, selecting a second worker node of the set of worker nodes for scheduling of the workload.

7. The system of claim 1, wherein the operations further comprise, in response to determining that the worker node is invalid, causing at least one remedial action to be performed to address the worker node.

8. A method comprising:
receiving, by at least one processing device, a workload;
selecting, by the at least one processing device from a set of worker nodes of a cluster environment, a worker node for scheduling of the workload;
determining, by the at least one processing device, whether the worker node is valid, including determining whether the worker node is trusted; and
in response to determining that the worker node is valid, scheduling, by the at least one processing device, the workload with the worker node.

9. The method of claim 8, wherein selecting the worker node comprises identifying the worker node using load balancing based on an analysis of available computing resources.

10. The method of claim 8, wherein determining whether the worker node is trusted comprises determining whether an attestation lease associated with a trust agent of the worker node is valid.

11. The method of claim 8, further comprising:
obtaining, by the at least one processing device, workload identity data corresponding to the workload; and
validating, by the at least one processing device, the workload using the workload identity data.

12. The method of claim 11, further comprising obtaining, the at least one processing device, a proof of attestation corresponding to the worker node, and wherein the workload identity data is generated based on the proof of attestation.

13. The method of claim 8, further comprising, in response to determining that the worker node is invalid, selecting, by the at least one processing device, a second worker node of the set of worker nodes for scheduling of the workload.

14. The method of claim 8, further comprising, in response to determining that the worker node is invalid, causing, by the at least one processing device, at least one remedial action to be performed to address the worker node.

15. A system comprising:
a control plane comprising a processing device, operatively coupled to a memory, to perform operations comprising:
receiving, from a trust agent of a worker node of a cluster environment, attestation verification data for comprising trust measurement data defining a configuration state of the worker node;
determining whether the worker node is valid by performing an attestation of the worker node based on the trust measurement data; and
in response to determining that the worker node is valid, sending a proof of attestation to the worker node.

16. The system of claim 15, wherein determining whether the worker node is valid comprises determining whether the trust measurement data matches reference trust measurement data.

17. The system of claim 15, wherein the operations further comprise:
receiving, from the worker node, a get nonce request to initiate an attestation process of the worker node;
identifying, using a node state store, a node state of the worker node related to an attestation lease;
determining, based on the node state of the worker node, whether to continue with the attestation process;
in response to determining to continue with the attestation process, storing nonce data associated with the get nonce request;
sending, to the worker node, a get nonce response; and
after sending the get nonce response, receiving the attestation verification data from the trust agent of the worker node.

18. The system of claim 15, wherein the operations further comprise:
receiving, from the worker node, a registration request to register the worker node with the control plane; and
in response to receiving the registration request, initiating a registration phase of an enrollment process to register the worker node with the control plane.

19. The system of claim 18, wherein the operations further comprise:
determining whether the registration phase is successful; and
in response to determining that the registration phase is successful, initiating an enrollment phase of the enrollment process.

20. The system of claim 19, wherein the operations further comprise:
determining whether the enrollment phase is successful; and
in response to determining that the enrollment phase is successful, initiating the attestation of the worker node.
